(19) United States
(12) Patent Application Publication
(10) Pub. No.: US 2007/0271148 A1
(43) Pub. Date: Nov. 22, 2007

(54) SYSTEMS AND METHODS FOR ONLINE REVERSE AUCTIONS

(76) Inventor: Simon Kapenda, Westerville, OH (US)

Correspondence Address: RuttlerAdams, LLC;Jim Ruttler, PMB 1131, 1122 East Pike Street, Seattle, WA, 98122, US

(21) Appl. No.: 11/306,698

(22) Filed: Jan. 8, 2006

(51) Int. Cl. G06Q 30/00

(52) U.S. Cl. 705/26

(57) ABSTRACT

This invention relates generally to auctions, and more specifically, to systems and methods for online reverse auctions. In one embodiment, the invention includes a system for providing an online reverse auction, the system having a software application, the software application being accessible to a buyer and a provider over a wide area network, wherein the software application is configured to receive an offer solicitation from the buyer and to present the offer solicitation to the provider, wherein the software application is configured to receive an offer from the provider responsive to the offer solicitation, and wherein the software application is configured to present the offer to the buyer.

### FIELD OF THE INVENTION

This invention relates generally to auctions, and more specifically, to systems and methods for online reverse auctions.

### BACKGROUND

Prior to recent technological advancements, particularly the internet, business was conducted in a relatively primitive fashion. The typical traditional business venture began by reserving physical office space and after locating the office space, managers would quickly locate renovation companies to adapt the office space to the required specifications. The process of locating renovation companies was typically done by evaluating their advertisements, billboards, radio ads, television ads, phonebook ads, or even by word of mouth. While the business was being outfitted, the managers collected the necessary employees. To do so, the business positioned itself as a seller and solicited persons, perhaps through the newspaper or a rudimentary sign in the window. After employees were organized and the physical office was renovated, the business turned its attention to purchasing equipment. Once again, the business consulted advertisements to affirmatively set out and locate equipment suppliers. The business continued its organizational preparations by similarly locating suppliers through their advertisements. With the physical office set up, equipment functioning, employees hired, and suppliers confirmed, the business set out to begin selling products. Once again, the traditional business turned to the time tested method of advertising its services, which required consumers or downstream manufacturers or distributors to consult advertisements for the products and services they needed. Indeed, the system of sellers advertising their products and services was regularly practiced up and down the supply chain and it was deeply accepted that the burden was on the purchaser to locate the seller.

Fast forward to recent technological advances, particularly the internet. The internet needs little, if any, introduction at this moment in time. Simply put, it has, among other things, permitted providers of services and products to peddle their wares inexpensively and internationally, almost instantly. The physical office space is unnecessary in many instances, employees can work from distant continents, information can be shared instantaneously, suppliers are not limited to geographic regions, and consumers may be located internationally. This fundamental shift has permitted every mom & pop, student, sole proprietorship, partnership, small cap corporation, and large cap corporation to advertise to every individual in the entire world in just about a day.

Despite these revolutionary changes, the traditional notion that the burden is on the buyer to locate sellers is still pervasive. Indeed, search engines have become extremely popular in relatively little time precisely because of their ability to facilitate this very process. Stated differently, search engines facilitate the buyer's burden of searching for providers of information, products, or services. For instance, assume that one wishes to locate a seller of boat parts. A simple search on a popular search engine proudly boasts that in under a second, two hundred and forty-seven thousand websites with the words “boat parts” and suppliers will be available to the searcher. Similarly, a search for a watch store yields ninety one million, one hundred thousand results. Finally, a search for a civil rights law firm yields six million, three hundred, and eighty thousand results.

One would expect that with six million, three hundred, and eighty thousand websites relating to civil rights law firms that it would be relatively easy to locate and find a civil rights attorney to answer some questions. However, paradoxically, the exact opposite is true and the amount of information effectively cripples the purchaser by pushing them into inaction through information overload. The searcher is left no better off with all the necessary information directly at hand. This apparent conundrum is solely attributable to the traditional notion that the burden is on the buyer to search for the seller.

What are needed, therefore, are systems and methods for shifting the burden to providers through online reverse auctions. This invention solves this and many other problems.

### SUMMARY OF THE INVENTION

This invention relates generally to auctions, and more specifically, to systems and methods for online reverse auctions. In one embodiment, the invention includes a system for providing an online reverse auction, the system having a software application, the software application being accessible to a buyer and a provider over a wide area network, wherein the software application is configured to receive an offer solicitation from the buyer and to present the offer solicitation to the provider, wherein the software application is configured to receive an offer from the provider responsive to the offer solicitation, and wherein the software application is configured to present the offer to the buyer. In one particular embodiment, the offer solicitation is for any of a good and service. In another particular embodiment, the software application is configured to receive the offer solicitation without a fee and the software application is configured to present the offer solicitation without a fee.

### BRIEF DESCRIPTION OF THE DRAWINGS

Embodiments of the present invention are described in detail below with reference to the following drawings:

FIG. 1 is a block diagram of a system for providing online reverse auctions, in accordance with an embodiment of the invention;

FIG. 2 is a block diagram of a method of operating as a buyer in an online reverse auction, in accordance with an embodiment of the invention;

FIG. 3 is a block diagram of a method of operating as a provider in an online reverse auction, in accordance with an embodiment of the invention; and

FIG. 4 is a block diagram of a method of operating as a buyer and a provider in an online reverse auction, in accordance with an embodiment of the invention.

### DETAILED DESCRIPTION

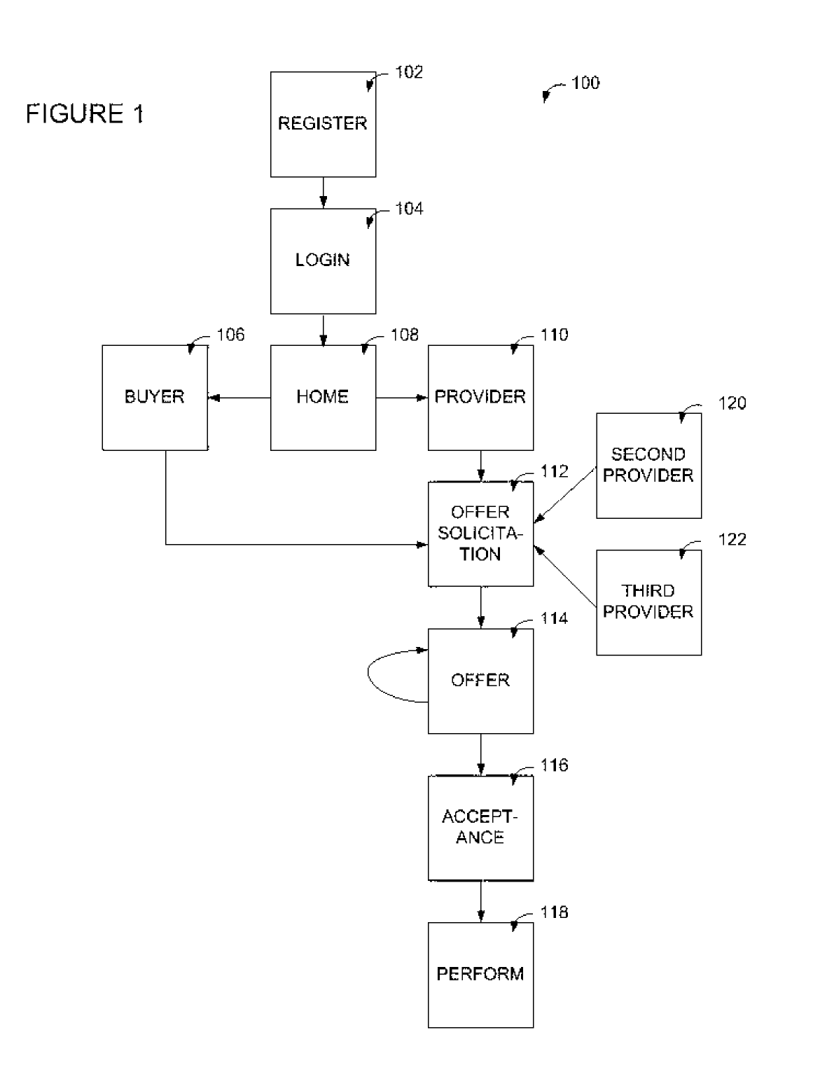

This invention relates generally to auctions, and more specifically, to systems and methods for online reverse auctions. Specific details of certain embodiments of the invention are set forth in the following description and in FIGS. 1-4 to provide a thorough understanding of such embodiments. The present invention may have additional embodiments, or may be practiced without one or more of the details described for any particular described embodiment.

FIG. 1 is a block diagram of a system for providing online reverse auctions, in accordance with an embodiment of the invention. Software system 100 includes a register component 102, a login component 104, a buyer component 106, a home component 108, a provider component 110, an offer solicitation component 112, an offer component 114, an acceptance component 116, a perform component 118, a second provider component 120, and a third provider component 122.

In one embodiment, a user registers at the register component 102 before logging into the system 100 through the login component 104. After logging in through the login component 104, the user advances to the home component 108. From the home component 108, the user may optionally enter the buyer component 106 or the provider component 110. When the user enters the buyer component 106, the user (i.e. a buyer) is able to post an offer solicitation for a desired good or service that is viewable in the offer solicitation component 112. When the user enters the provider component 110, the user (i.e. the provider of a good or service) is able to view the offer solicitation for a desired good or service through the offer solicitation component 112. Other providers may enter through the second provider component 120 and the third provider component 122 to similarly view the offer solicitation for a desired good or service through the offer solicitation component 112 (any number of providers may view the offer solicitation for a desired good or service). Any of the providers may submit an offer to provide the desired good or service in response to the offer solicitation at the offer component 114. The buyer may optionally accept any offer from any provider to deliver the desired good or service at the acceptance component 116. After mutual assent the buyer and the winning provider perform at the perform component 118, wherein the provider delivers the promised good or service and the buyer tenders payment.

In one particular embodiment, the registration component 102 is programmable to capture any demographic information, a username, or a password, which is optionally editable in whole or in part. In another particular embodiment, the registration component 102 is optionally programmable to receive payment for using the system 100 in whole, in part, based on time, or based on usage. In a further particular embodiment, no payment is received for posting or viewing an offer solicitation for a desired good or service and payment is received for making an offer to provide the desired good or service based on any of a given offer solicitation category, time period, attempt, or other methodology. In yet another particular embodiment, the registration component 102 and the login component 104 are not present in the system 100 or are capable of being bypassed. In yet another particular embodiment, the registration component 102 includes any of the functions present anywhere else in the system 100 and any of the functions of the registration component 102 are present in any part of the system 100.

In another particular embodiment, the home component 108 is programmable to provide any of navigation, management tools, support functions, information, services, or other related information or function. In one particular embodiment, the management tools include any of payment management, offer solicitation list management, favorite provider list management, favorite offer list management, resume creation tools, job applicant list management, bid list management, project list management, delivery list management, favorite buyer list management, favorite offer solicitation list management, statistics, editing functions, mail management, sharing tools, or other related information or function. In another particular embodiment, the support functions include any of telephone, email, text message, online chat, personal, frequently asked questions or other support. In yet another particular embodiment, the information includes any of about the system 100, investors of the system 100, careers in the system 100, policies of the system 100, security for the system 100, announcements in the system 100, credits for the system 100, contact information for the system 100, or other related information. In another particular embodiment, the services include any of communication with other users, a confidential workspace, statistics, promotion, personal webpage construction, feedback, automatic contact for new offers, offer solicitations, or users, offer solicitation posting, offer posting, credential confirmation, positioning, or other related service. In yet a further particular embodiment, the home component 108 is optionally omitted or bypassed in whole or in part. In a further particular embodiment, the home component 108 includes any of the functions described anywhere in the system 100 and any of the functions described in the home component 108 are present anywhere in the system 100.

In another embodiment, the buyer component 106 permits the user (i.e. a buyer) to post an offer solicitation for a desired good or service. In one particular embodiment, the buyer may be any of an individual, a company, a manufacturer, a distributor, a retailer, a provider or any other person or group. In another particular embodiment, the offer solicitation for a desired good or service includes any of an identification, a budget, desired terms, desired rates, desired locations, applicable category, desired audience (general or specific), blacklisted providers, description, desired time frame for performance, desired time frame for offers, associated documents or images, website links, special treatment options (borders, better placement, credential verification), profit vs. non-profit designation, notes, desired delivery method, desired payment method, close early options, or other related information. In another particular embodiment, the applicable category includes any of legal services, housing, an automobile, a home improvement item, a job, personals, a book, a home item, a garden item, a consumer electronic, a gift, jewelry, a health item, a memorabilia, a movie, music, a doll, an instrument, pottery, a sporting good, a sporting card, a mobile phone, a stamp, a ticket, a toy, a computer, a travel item, a video game, art, a clothing item, a coin, an antique, a baby item, a camera, a collectible, a craft, an entertainment item, a finance item, a business item, and a specialty service. In one embodiment, the buyer component 106 is optionally omitted or bypassed. In yet a further particular embodiment, the buyer component 106 includes any function present in any other component of the system 100 and any other component of the system 100 includes any function of the buyer component 106.

In another embodiment, the provider component 110 permits the user (i.e. the provider of a good or service) to view an offer solicitation for a desired good or service through the offer solicitation component 112. The second provider component 120 and the third provider component 122 similarly permit other providers to view the offer solicitation for a desired good or service through the offer solicitation component 112 (any number of providers may view the offer solicitation for a desired good or service). In one particular embodiment, the provider is any of a supplier, manufacturer, retailer, professional, private owner, employee, buyer, or other peddler of goods or services. In one particular embodiment, the offer solicitation for a desired good or service is any of organized by category, organized by subcategory, searchable, filterable, viewable with details, viewable with history, viewable with past questions, or other similar feature. In another particular embodiment, the offer solicitation component 112 is further programmable to permit the provider to view any of information on the buyer, offers placed by other providers, past communications between the buyer and providers, or other related information. In another particular embodiment, the information on the buyer includes any of credentials, feedback, history, statistics, ratings, longevity, payment method, activities, previous questions answered, offer solicitation history, description, or other related information. In yet a further particular embodiment, the offer solicitation component 112 is programmable to facilitate public or private communications between the provider and the buyer, including, but not limited to, sharing documents, images, or files. In yet another embodiment, the provider component and the offer solicitation component are integrated in whole or in part to a single component, are omitted, or are capable of being bypassed. In yet a further particular embodiment, any function of any other component in the system 100 is present in the provider component 110 or the offer solicitation component 112 and any function of the provider component 110 or offer solicitation component 112 is present in any other component in the system 100. In another particular embodiment, the system 100 prevents blanket offers or offer solicitations, such as those generated by a computer program.

In another embodiment, the offer component 114 is programmable to permit a provider to submit an offer to a buyer responsive to an offer solicitation for a desired good or service. In one particular embodiment, the offer includes any of a description of product or services proposed, a type of product or services proposed, a price, a rate, or any other information useful in making an offer to provide the desired good or service. In another particular embodiment, multiple offers to provide the desired good or service may be received by the offer component 114 for any given provider. In one particular embodiment, the offer component 114 is omitted or bypassed. In yet a further particular embodiment, the offer component 114 includes any function of any other component in the system 100 and any function of the offer component 114 is present in any other component of the system 100.

In another embodiment, the acceptance component 116 is programmable to permit a buyer to accept any offer to provide the desired good or service. In one particular embodiment, the acceptance is based on principled reasoning, arbitrary, or not disclosed. In a further particular embodiment, the buyer accepts the offer at anytime, at a predetermined time, or never. In one embodiment, the acceptance is communicated to a winning provider through any viable communications medium. In one particular embodiment, the acceptance component 116 is omitted or bypassed. In yet a further particular embodiment, the acceptance component 116 includes any function from any other component of the system 100 and any other component of the system 100 includes any function of the acceptance component 116.

In another embodiment, the perform component 118 is programmable to facilitate the performance of any agreement between a buyer and a provider. This includes any of payment transaction services, escrow services, legal services, tracking services, follow-up services, or any other related service. In one particular embodiment, the perform component 118 is omitted or bypassed. In one particular embodiment, the perform component 118 includes any function from any other component in the system 100 and any other component of the system 100 includes any function of the perform component 118.

In another embodiment, the functions of the system 100 are distributed between fewer or greater components. In yet another embodiment, the components are distributed between multiple computers or are consolidated to a few or one computer. In an alternative embodiment, the system 100 operates in a personal computer, a mobile or landline telephone, handheld, automotive computer, a physical system, or over any other known or later discovered technology.

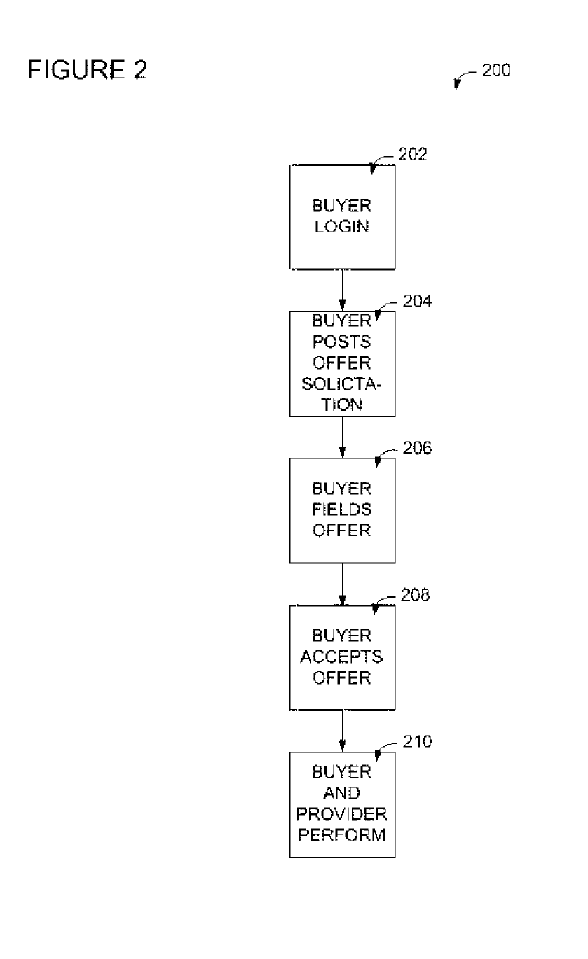

FIG. 2 is a block diagram of a method of operating as a buyer in an online reverse auction, in accordance with an embodiment of the invention. Method 200 includes a buyer logging in at block 202, posting an offer solicitation at block 204, fielding offers at block 206, accepting an offer at block 208, and performing with the provider at block 210. In one particular embodiment, the method 200 is performed by using a software system over a wide area network such as the internet, but the method 200 may also be performed in person, over the phone, or using another related technology.

In one embodiment, the logging in at block 202 includes using an identifier and a password for authentication. The identifier and the password are either pre-selected or pre-assigned. In one particular embodiment, the logging in at block 202 is omitted or bypassed.

In one embodiment, the posting an offer solicitation at block 204 includes manifesting a desire for any good or service. In one particular embodiment, the manifestation is accomplished by any of selecting a category, such as personals, community, resumes, legal, auto, housing, jobs, miscellaneous; selecting a subcategory; inputting a description; choosing an ID; inputting a budget; setting desired terms; selecting a preferred rate; determining the location; selecting the audience; noting blacklisted providers; choosing a timeframe; uploading associated files; providing a website link; selecting open/close offer solicitation periods; choosing special treatment options; marking profit/non-profit status; inputting notes; choosing a delivery and payment method; or any other information useful in manifesting a desire for a good or service.

In one embodiment, the fielding offers at block 206 includes reviewing and evaluating any offer submitted by a provider to provide the desired good or service. The offer may include any of a provider company name, a description of the good or service offered, a type of service or good, a rate, a time period, terms, a payment method, references, credentials, contact information, location, questions, files, statistics, history, rating, longevity, offer history, expiration date, or other information useful in relation to an offer to provide a good or service.

In one embodiment, the accepting the offer at block 208 includes manifesting assent to an offer to provide desired good or service at anytime or at a predetermined time. The accepting may be based on arbitrary, well-reasoned, or non-disclosed principles. In another embodiment, the performing with the provider at block 210 includes following through with the elements of the bargain agreed to.

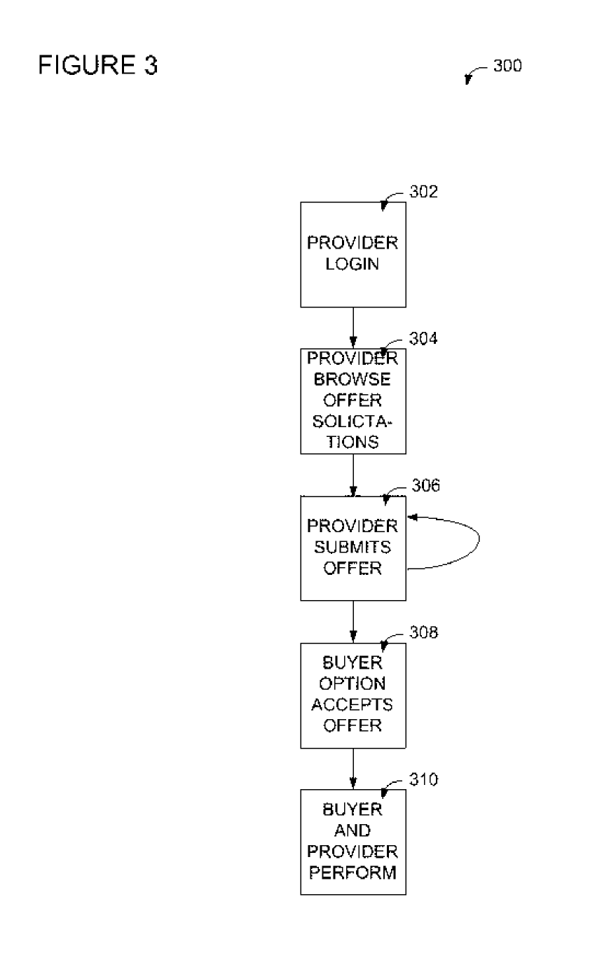

FIG. 3 is a block diagram of a method of operating as a provider in an online reverse auction, in accordance with an embodiment of the invention. The method 300 includes a provider logging in at block 302, browsing an offer solicitation at block 304, submitting an offer at block 306, waiting for a buyer to optionally accept the offer at block 308, and performing upon mutual assent at block 310. In one particular embodiment, the method 300 is performed by using a software system over a wide area network such as the internet, but the method 300 may also be performed in person, over the phone, or using another related technology.

In one embodiment, the logging in at block 302 includes using an identifier and a password for authentication. The identifier and the password are either pre-selected or pre-assigned. In one particular embodiment, the logging in at block 302 is omitted or bypassed.

In one embodiment, the browsing an offer solicitation at block 304 includes viewing a buyer's offer solicitation for desired good or service. In one particular embodiment, a provider can filter or search multiple offer solicitations for goods or services. In one particular embodiment, a particular offer solicitation for a desired good or service is viewed with associated information, including any of an ID, budget, terms, rate, location, category, audience, description, time frame, associated files, website links, open/close bidding dates, notes, profit/non-profit status, delivery method, or other information useful in relation to an offer solicitation. In another particular embodiment, the provider can make private or public inquiries or upload files to the buyer for review in relation to the offer solicitation. In yet another particular embodiment, the provider can view offers from other providers, information on the buyer, feedback on the buyer, history of the buyer, statistics of the buyer, ratings on the buyer, longevity of the buyer, activities of the buyer, previously posted questions or files to the buyer, dealing histories between the buyer and providers, or other related information.

In one embodiment, the submitting an offer at block 306 includes making an offer to provide the desired good and service. The offer may include any of a provider company name, a description of the good or service offered, a type of service or good, a rate, a time period, terms, payment method, references, credentials, contact information, location, questions, files, statistics, history, rating, longevity, offer history, expiration date, or other useful information. In one particular embodiment, the offer is rescindable.

In one embodiment, the waiting for a buyer to optionally accept the offer at block 308 includes reviewing newly posted offers to provide the desired good or service from other providers and/or re-posting a more competitive offer to the buyer to provide the desired good or service. In another embodiment, the performing upon mutual assent at block 310 includes providing the good or service bargained for.

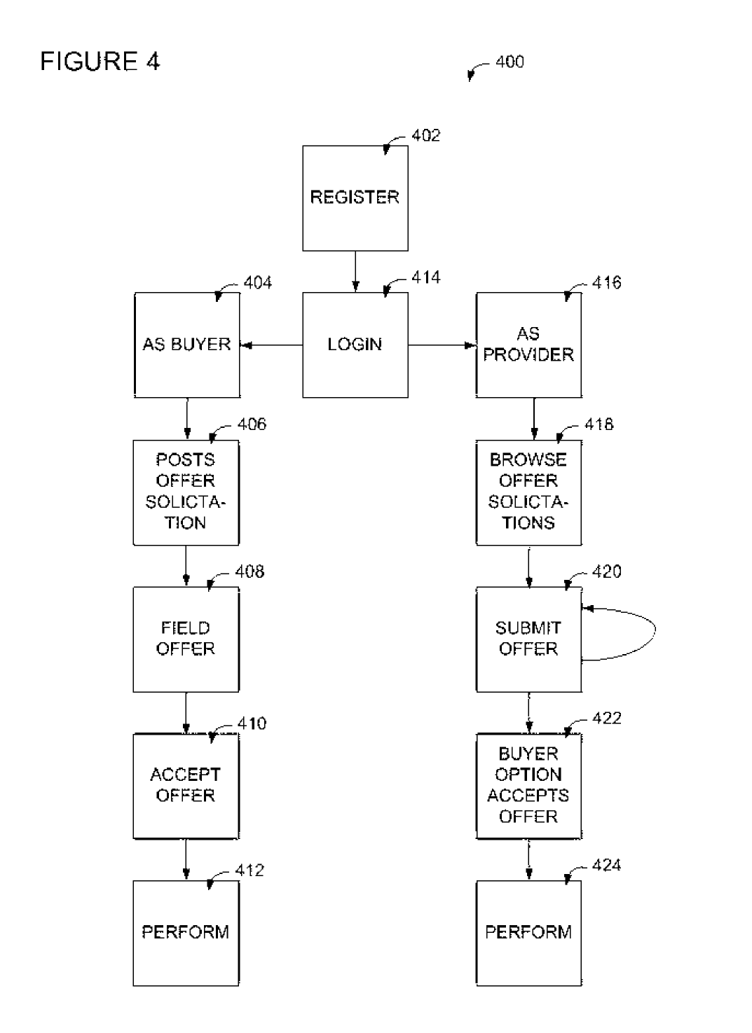

FIG. 4 is a block diagram of a method of operating as a buyer and a provider in an online reverse auction, in accordance with an embodiment of the invention. The method 400 includes the method 200 and the method 300, and is illustrative that a single user may operate as either or both a buyer of a desired good or service and a provider of a desired good and service. The steps are substantially similar to those set forth above in relation to FIGS. 2 and 3. In one embodiment, the registering at block 402 includes providing demographic information, the demographic information being optionally editable. The registering at block 402 also may optionally include submitting payments. However, the registering at block 402 may be omitted or bypassed. Also, payments may be collected at alternative steps in method 400 or omitted.

While preferred and alternate embodiments of the invention have been illustrated and described, as noted above, many changes can be made without departing from the spirit and scope of the invention. Accordingly, the scope of the invention is not limited by the disclosure of these alternate embodiments. Instead, the invention should be determined entirely by reference to the claims that follow.

What is claimed is:

1. A system for providing an online reverse auction, the system comprising:
a software application, the software application being accessible to a buyer and a provider over a wide area network,
wherein the software application is configured to receive an offer solicitation from the buyer and to present the offer solicitation to the provider, wherein the software application is configured to receive an offer from the provider responsive to the offer solicitation, and wherein the software application is configured to present the offer to the buyer.

2. The system for providing an online reverse auction of claim 1, wherein the offer solicitation is for any of a good and service.

3. The system for providing an online reverse auction of claim 1, wherein the software application is configured to receive the offer solicitation without a fee and wherein the software application is configured to present the offer solicitation without a fee.

4. The system for providing an online reverse auction of claim 2, wherein the offer solicitation is for any of legal services, housing, an automobile, a home improvement item, a job, personals, a book, a home item, a garden item, a consumer electronic, a gift, jewelry, a health item, a memorabilia, a movie, music, a doll, an instrument, pottery, a sporting good, a sporting card, a mobile phone, a stamp, a ticket, a toy, a computer, a travel item, a video game, art, a clothing item, a coin, an antique, a baby item, a camera, a collectible, a craft, an entertainment item, a finance item, a business item, and a specialty service.

5. A system for providing an online reverse auction, the system comprising:
a buyer component, the buyer component configured to receive an offer solicitation from a buyer;
a provider component, the provider component in communication with the buyer component, the provider component configured to present the offer solicitation to a provider, the provider component configured to receive an offer from the provider responsive to the offer solicitation,
wherein the offer is presented to the buyer for consideration.

6. The system for providing an online reverse auction of claim 5, wherein the offer solicitation is for any of a good and service.

7. The system for providing an online reverse auction of claim 5, wherein the buyer component is configured to receive the offer solicitation without a fee and wherein the provider component is configured to present the offer solicitation without a fee.

8. The system for providing an online reverse auction of claim 6, wherein the offer solicitation is for any of legal services, housing, an automobile, a home improvement item, a job, personals, a book, a home item, a garden item, a consumer electronic, a gift, jewelry, a health item, a memorabilia, a movie, music, a doll, an instrument, pottery, a sporting good, a sporting card, a mobile phone, a stamp, a ticket, a toy, a computer, a travel item, a video game, art, a clothing item, a coin, an antique, a baby item, a camera, a collectible, a craft, an entertainment item, a finance item, a business item, and a specialty service.

9. A method for providing an online reverse auction, the method comprising the steps of:
receiving an offer solicitation from a buyer without a fee, the offer solicitation being for any of a good and service;
presenting the offer solicitation to a provider without a fee;
receiving an offer from the provider responsive to the offer solicitation; and
presenting the offer to the buyer for consideration.
